(19) United States
(12) Patent Application Publication
(10) Pub. No.: US 2004/0141758 A1
(43) Pub. Date: Jul. 22, 2004

(54) System and method for providing multiple services to a destination via a fiber optic link

(76) Inventor: Jamil O. El-Reedy, Allen, TX (US)

Correspondence Address: Michael L. Diaz, Michael L. Diaz, P.C., Suite 200, 555 Republic Drive, Plano, TX, 75074, US

(21) Appl. No.: 10/349,259

(22) Filed: Jan. 22, 2003

(51) Int. Cl. H04B 10/00

(52) U.S. Cl. 398/167.5; 398/43

(57) ABSTRACT

A system and method of providing multiple simultaneous services to several destinations is disclosed. The system includes a central office providing multiple digital services to several destinations. In addition, the system includes a curbside hub directing signals sent from the central office to the destinations. Each destination also includes a home-side interface unit for receiving and sending signals between the destination and the curbside hub. The curbside hub is located within the vicinity of the destinations. The curbside hub is connected to the central office by a first fiber optic link. Additionally, the curbside hub is connected to each home-side interface unit by a home-side fiber optic link. The curbside hub electrically multiplexes and demultiplexes signals between each home-side interface unit and the curbside hub. The curbside hub also optically multiplexes and demultiplexes signals transferred between the central office and the curbside hub. The system provides a cost-effective implementation of multiple digital services via a fiber optic network to residences.

### BACKGROUND OF THE INVENTION

1. Technical Field of the Invention

This invention relates to fiber optic networking and, more particularly, to a system and method for providing multiple services to a destination via a fiber optic link.

2. Description of Related Art

In recent years, consumers have increasingly desired higher speed Internet access, multiple phone lines, full service digital cable services, and other communication services. In addition, many consumers also desire greater bandwidth to provide robust communication links to other nodes. To achieve this desire for greater and faster communication links, communication companies have initiated the use of fiber optic links. The fiber optic links typically exchange optical signals between a central office and several destinations subscribing to the service offered by the central office. These fiber optic links are quite attractive in terms of their ability to deliver a wide variety of services. However, the cost of deploying such fiber optic networks is tremendous. Of course communication companies utilizing fiber optic networks pass a large portion of the cost to their customer. Due to the high cost associated with these systems, customers, as well as the communication companies, are reluctant to provide fiber optic links directly to a large market, namely, residential customers. Obviously, residential customers are not as likely to spend large amounts of money to utilize a fiber optic network. Thus, communication companies do not provide a greatly desired fiber optic network to a residence, which causes loss of revenue from a high percentage of the customers.

Although there are no known prior art teachings of a system or method such as that disclosed herein, prior art references that discuss subject matter that bears some relation to matters discussed herein are U.S. Pat. No. 5,754,941 to Sharpe et al. (Sharpe), U.S. Pat. No. 5,864,415 to Williams et al. (Williams), U.S. Pat. No. 6,141,126 to Lahat et al. (Lahat), U.S. Pat. No. 6,370,571 to Medin, Jr. (Medin), and U.S. Pat. No. 6,385,366 to Lin (Lin).

Sharpe discloses a broadband fiber optic communication system which conveys telecommunication messages over a fiber optic link between a master side and one or more remote sites. The remote sites are coupled over an unshielded twisted pair-configured communication link to an optical network unit ported to the fiber optic link. However, Sharpe does not teach or suggest a fully digital service which utilize a fiber optic link between a destination and a central location. Sharpe merely discloses an analog service over a fiber optic link. Sharpe suffers from the disadvantage of encoding one service at a time over the link.

Williams discloses a fiber optic network having an optical fiber connection from a central office to an intelligent interface device in the subscriber's premises. The central office includes a serving node transceiver providing communication links to and from at least a narrowband switch and a service routing. The network includes at least one passive power splitter/combiner for passing all wavelengths on the optical fiber connection between the serving node transceiver and the intelligent interface devices. All wavelengths are provided to each customer. The bandwidth on the optical fiber loop is dynamically allocated for individual services on demand through two-way wavelength division multiplexing and demultiplexing. However, Williams does not teach or suggest providing a single fiber optic line to a destination providing selective, multiple services to the destination. Williams provides multiple services utilizing different wavelengths for each service, which is a tremendous waste of fiber optic resources. Thus, Williams is a far more costlier network architecture than the present invention. In addition, Williams does not disclose an intermediate hub node leading to a central office.

Lahat discloses an optical switch using wavelength division multiplexing (WDM) or dense wavelength division multiplexing (DWDM) techniques for use in both wide area network (WAN) and local area network (LAN) environments. Each input to the switch is assigned a separate wavelength via a tunable transmitter. The output of the transmitter is inputted to a star coupler which combines all the optical signals into a single optical output signal. This signal is inputted to an optical demultiplexer which functions to split the incoming optical signal into a plurality of separate wavelengths with each wavelength steered into a particular output port. However, Lahat does not teach or suggest a system providing a single fiber optic link from the service provider to the neighborhood hub. Lahat merely discloses the process of multiplexing signals over a fiber optic link.

Medin discloses a distributed network architecture and processes for the delivery of high-performance, end-to-end online multimedia services, including Internet services. The network architecture connects a high-speed private backbone to multiple network access points of the Internet, to multiple regional servers in regional data centers. Each of the regional servers connects to several caching servers in modified headends, which connect via fiber optics to many neighborhood nodes. Each node then connects via coaxial cable to multiple end-user systems. However, Medin does not teach or suggest linking a plurality of homes to the neighborhood hub. Medin, merely discloses using a coaxial cable linking the neighborhood hub to each home.

Lin discloses a method of operating a hybrid fiber coax transmission system to provide Fiber to the Home Office. The method includes directing, via a fiber portion of the transmission system, a WDM optical signals corresponding to a first category of subscriber service. The first wavelength division multiplexed optical signals, which are within a first wavelength band, originate at a primary hub or headend and are sent to a plurality of fiber nodes where they are converted to respective electrical signals. The converted electrical signals are transmitted, via a coaxial cable portion of the transmission system, to the homes of individual subscribers. The method also includes the step of exchanging, via a fiber portion of the transmission system, demultiplexed second WDM optical signals corresponding to fiber-to-the-home office server between a headend and the home of at least one of the individual subscribers. However, Lin does not teach or suggest linking a plurality of homes to a neighborhood hub. In addition, Lin merely discloses utilizing coaxial cable providing out of band analog signals to the designation from the service provider.

Review of the foregoing references reveals no disclosure or suggestion of system or method which provides multiple services over a fiber optics link in a cost-effective manner. It is an object of the present invention to provide such a system and method.

### SUMMARY OF THE INVENTION

In one aspect, the present invention is a system for providing multiple services to a destination on a fiber optic network. The system includes a central office providing multiple services to a plurality of destinations. Each destination has a home-side interface unit coupled to a plurality of service interface units providing services to an occupant of each destination. The system also includes a curbside hub connected to the central office via a first fiber optic link. The curbside hub is connected to each destination by a home-side fiber optic link. The curbside hub transfers signals to and from each destination to provide multiple services to each destination.

In another embodiment of the present invention, the system is a system for providing multiple services to a destination via a fiber optic link. The system includes a central office providing multiple services to a plurality of destinations. Each destination has a home-side interface unit coupled to a plurality of service interface units providing services to an occupant of each destination. The system also includes a curbside hub connected to the central office via a first fiber optic link. The curbside hub is connected to each destinations by a home-side fiber optic link. The curbside hub demultiplexes signals received from the central office via the first fiber optic hub and wavelength division multiplexes signals being sent to the central office via the first fiber optic link. The curbside hub also time division multiplexes signals received from each home-side interface sending signals to the curbside hub via the home-side fiber optic hub. The signals provide services via the first fiber optic link and each home-side fiber optic link to each destination.

In still another aspect, the present invention is a system for providing multiple services to a destination via a fiber optic link. The system includes a central office providing multiple services to a plurality of destinations. Each destination has a home-side interface unit coupled to a plurality of service interface units providing services to an occupant of each destination. The system also includes a curbside hub connected to the central office via a first fiber optic link. The curbside hub is connected to each destination by a home-side fiber optic link. The curbside hub optically multiplexes and demultiplexes signals transferred between the curbside hub and the central office. The curbside hub also electrically multiplexes and demultiplexes signals transferred between the curbside hub and each home-side interface unit.

In another aspect, the present invention is a method of providing multiple simultaneous services to a plurality of destinations via a fiber optic network. The method begins by the central office providing services via a first fiber optic link from a central office to a curbside hub. The curbside hub is connected to a plurality of home-interface units by a plurality of home-side fiber optic links. Each home-side unit is located at a destination. Next, the curbside hub demultiplexes signals associated with the services and determines a destination for each demultiplexed signal. Next, each determined, demultiplexed signal is directed to a destination via one of the home-side fiber optic links. The directed signal provides at least one service to the destination.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of a fiber optic network in the preferred embodiment of the present invention;

FIG. 2 is a simplified block diagram of an exemplary aggregation function card for use with an OC-3 link utilized in the network of FIG. 1;

FIG. 3 is a simplified block diagram of an exemplary aggregation function card for use with an OC-12 link utilized in the network of FIG. 1;

FIG. 4 is a simplified block diagram of the curbside hub;

FIG. 5 is a simplified block diagram of the WDM/TDM deployment within the network in the preferred embodiment of the present invention;

FIG. 6 is a block diagram of an exemplary protocol stack for use in providing multiple services to a residence through the network;

FIG. 7 is a high level diagram of the components of the curbside hub of the network in the preferred embodiment of the present invention;

FIG. 8 is a high level diagram of the components of the home-side interface unit of the network in the preferred embodiment of the present invention;

FIG. 9 is a simplified block diagram of the end to end network illustrating a plurality of services available from the central office in the preferred embodiment of the present invention;

FIG. 10 is a simplified block diagram of the digital cable system architecture in a digital cable broadcast scheme for the network of FIG. 9;

FIG. 11 is a simplified block diagram of a Remote User Interface (RUI) type-1 system architecture within the residence;

FIG. 12 is a simplified block diagram of an RUI type-2 system architecture within the residence;

FIG. 13 is a simplified block diagram of a network in a first alternate embodiment of the present invention; and

FIG. 14 is a simplified block diagram of a network in a second alternate embodiment of the present invention.

### DETAILED DESCRIPTION OF EMBODIMENTS

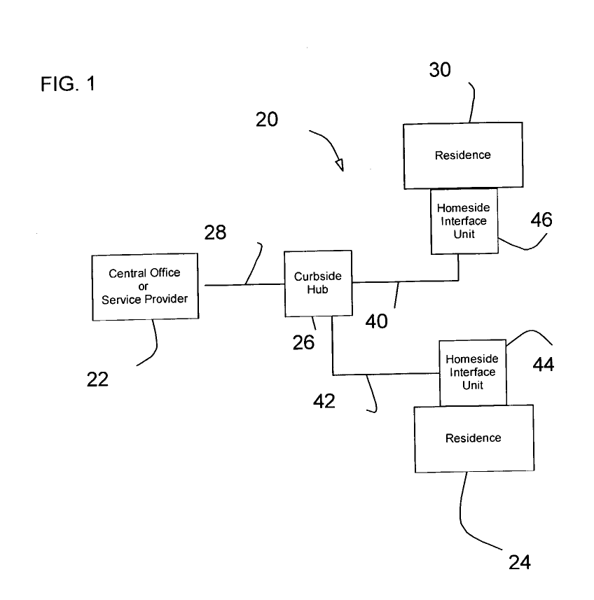

The present invention is a system and method for providing multiple services to a destination via a fiber optic link. FIG. 1 is a simplified block diagram of a fiber optic network 20 in the preferred embodiment of the present invention. The network includes a central office 22 (service provider) providing services to a customer's residence 24/30. Services provided by the central office are bidirectionally linked to a curbside hub 26 through a fiber optic link 28. In the preferred embodiment of the present invention, the link is an OC-48 or OC-192 link, which is well known in the fiber optics industry. The curbside hub is preferably located within the general vicinity of several residences. In this example, residence 24 and a residence 30 are serviced by the curbside hub 26.

The curbside hub 26 communicates with each of its servicing residences 24 and 30 through fiber optic links 40 and 42. In the preferred embodiment of the present invention, the fiber optic links and 42 are OC-3 or OC-12 fiber optic links, well known in the fiber optics industry. Each fiber optic link (40 and 42) leads to a home-side interface unit 44 and 46. The home-side interface unit provides an interface for receiving and transmitting optical signals through the fiber optic links 40 and 42. The home-side interface unit may provide multiple simultaneous, customized services to each residence, such as digital cable, telephone, movies on demand service, and high speed Internet access.

The fiber optic link 28 preferably employs several (preferably sixteen or thirty-two) OC-48 or OC-192 links from the central office 22 to the curb side hub 26. The multiple OC-48/192 links are wavelength division multiplexed (WDM) over the fiber optic link 28. The link may be used as an intermediate link (10-20 kilometers) or a longer range link (up to 40 kilometers) such as defined in industry standards well know to those skilled in fiber optics. At the curbside hub 26, the signals operating over the fiber optic link 28 are broken down into the number of OC-48/192 lines. The curbside hub includes several aggregation function cards 55 which may each be associated with a residence to provide the curbside hub services. Each aggregation function card breaks the signals received from the OC-48/192 lines into several fiber optic links, such as links 40 and 42. As illustrated, the links are OC-3 or OC-12 links. In the preferred embodiment of the present invention, the curbside hub may break down each of the individual OC-48/192 links into sixteen OC-3/12 links. Each OC-3/12 may provide multiple services to a residence.

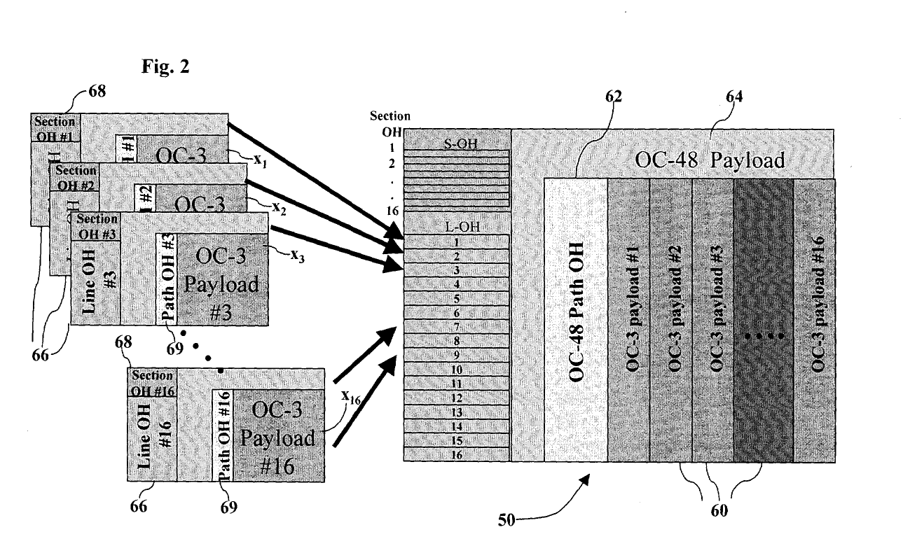

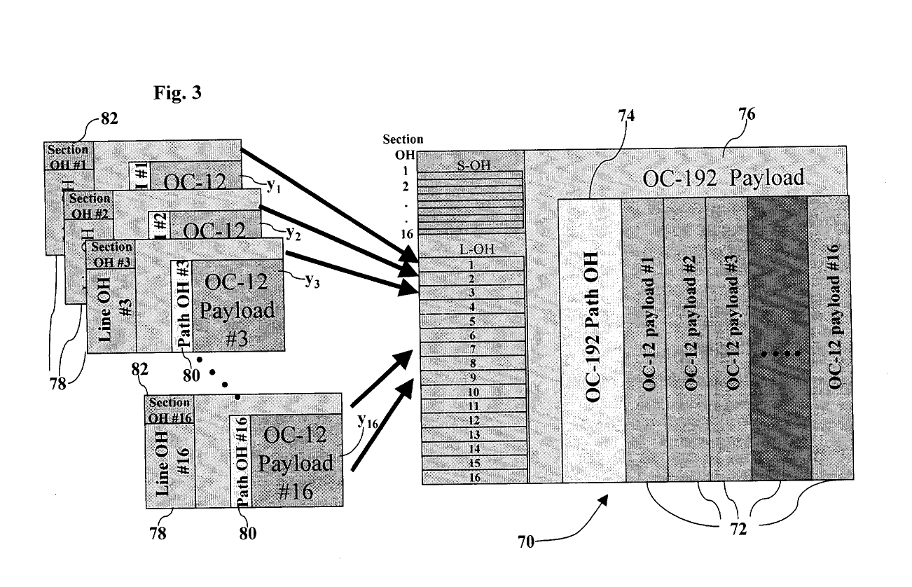

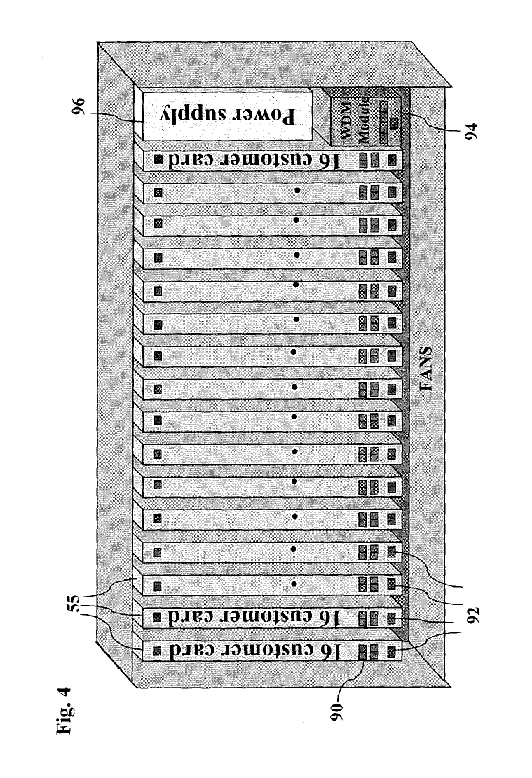

FIG. 2 is a simplified block diagram of an exemplary aggregation function 50 for use with an OC-3 link utilized in the network 20 of FIG. 1. The aggregation function 50 includes sixteen OC-3 payloads 60. Additionally, an OC-48 path overhead (OH) 62 and an OC-48 payload 64 is provided. The aggregation function card 55 also includes sixteen individual lines provided to the residence on sixteen channels of frames X1-X16. Each frame may include an Internet Protocol (IP)/packet over Synchronous Optical Network (SONET) payload. An STS-3 frame line overhead 66 of each frame selects the type of payload, such as SONET payloads, IP packets or asynchronous transfer mode (ATM) payloads. Each frame also includes a frame section overhead 68 and a frame path overhead 69. The OC-3 aggregation function 50 multiplexes or demultiplexes the customer frames originating or sent via the OC-48 link. The OC-3 aggregation function takes the sixteen OC-3 pipes and time division multiplexes (TDM) the pipes together. Each aggregation function 50 is associated with the curbside hub 26 discussed in FIG. 4. FIG. 3 is a simplified block diagram of an exemplary aggregation function 70 for use with an OC-12 link utilized in the network 20 of FIG. 1. The aggregation function 70 operates in a similar manner as discussed for the aggregation function 50. The aggregation function 70 differs only in aggregating the frames from sixteen OC-12 pipes by TDMing the pipes together. The function 70 includes sixteen OC-12 payloads 72, an OC-192 path overhead 74, and an OC-192 payload 76. In addition, each frame Y1-Y16 includes a frame line overhead 78, a frame path overhead 80, and a frame section overhead 82.

Various TDM muxing techniques may be employed in the present invention. For example, in a first embodiment a bit/byte interleaving technique may be used. In this embodiment, multiple pipes each have a stream of bits/bytes. The first bit/byte from pipe “1” may be added to the first bit/byte from pipe “2” and so forth for all the pipes. Next, the next bit/byte from pipe 1 is added, then the bit/byte from pipe 2, etc. is repeated.

In an alternate embodiment of the present invention, synchronous/asynchronous STS-1 muxing may be used. Multiple pipes each carry a stream of bytes buffered into a sequential series of STS-1 frames. With this type of muxing technique, STS-1 number 1 from pipe “1” is followed by STS-1 number 1 from pipe “2” and so forth for the remaining pipes. Then, STS-1 number 2 from pipe “1” is followed by STS-1 number 2 from pipe “2” and so on.

In still another alternate muxing technique, synchronous/asynchronous STS-3/3c muxing may be utilized. Again, multiple pipes each having a stream of bytes buffered into a sequential series of STS-3c frames are used. For this type of muxing, STS-3c number 1 from pipe “1” is followed by STS-3c number 1 from pipe “2” and so forth. Next, STS-3c number 2 from pipe “1” is followed by STS-3c number 2 from pipe “2” and so forth. Alternative, muxing may be accomplished by a mix, such as taking an STS-3c followed by three STS-1's. Additionally, other combinations may be utilized.

Another alternate muxing technique is synchronous/asynchronous STS-12/12c muxing. With multiple pipes each carrying a stream of bytes buffered into a sequential series of STS-12c frames. For this type of muxing, STS-12c number 1 from pipe “1” is followed by STS-12c number 1 from pipe “2” and so forth. Then, STS-12c number 2 from pipe “1” is followed by STS-12c number 2 from pipe “2” and so forth. Again, various combinations of muxing procedures may be employed, such as taking an STS-12c followed by four STS-3c, then several STS-1 frames.

Another synchronous/asynchronous STS-24/24c muxing may be utilized. With multiple pipes each carrying a stream of bytes buffered into a sequential series of STS-24c frames, muxing may be accomplished. For this type of muxing, STS-24c number 1 from pipe “1” is followed by STS-24c number 1 from pipe “2” and so forth. Next, STS-24c number 2 from pipe “1” is followed by STS-24c number 2 from pipe “2” and so on. Again, muxing procedures may be mixed.

The OC-3/12 aggregation functions 50 and 70 provide bidirectional multiplexing and demultiplexing of the OC-3 or OC-12 pipes. It should be understood that although sixteen OC-3/12 pipes are illustrated as being aggregated, any number of fiber optic links may be multiplexed or demultiplexed. The number and type of fiber optic links may be altered and still be utilized in the present invention.

FIG. 4 is a simplified block diagram of the curbside hub 26. The curbside hub is preferably located within the vicinity of the residences it services. However, in alternate embodiments of the present invention, the curbside hub may be remotely located away from the residences it services. The curbside hub include sixteen aggregation function cards 55. Each aggregation function card includes a ribbon connector 90 and an MU connection 92 (or any optical connector). The curbside hub may also include a WDM module 94 and a power supply 96 providing power to the curbside hub. The power supply may incorporate a CPU for controlling power allocation, alarms, performance monitors, equipment inventory, and support synchronization for the curbside hub. The ribbon connection breaks out into sixteen individual fibers and each is connected to a residence, providing signaling to and from the residence. The MU connection connects each aggregation function card to the WDM module. The WDM module optically multiplexes or demultiplexes a plurality of function cards. The multiplexed/demultiplexed signals are transferred via the fiber optic link 28 to the central office 22. As illustrated, there are sixteen aggregation function cards. Each aggregation function card may provide 16 customer services to the residences. Thus, each curbside hub may provide up to 256 customer services. The number of cards are exemplary only and it should be understood that any number of function cards may be utilized in the curbside hub.

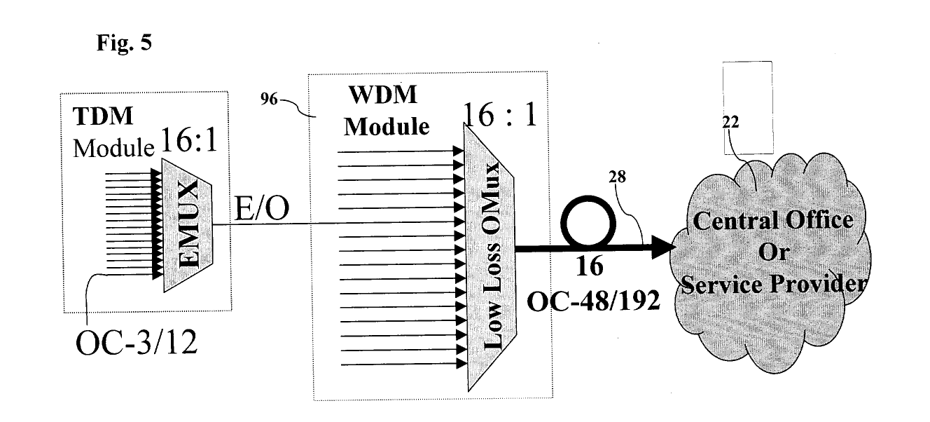

FIG. 5 is a simplified block diagram of the WDM/TDM deployment within the network 20 in the preferred embodiment of the present invention. As illustrated, sixteen OC-3 or OC-12 pipes are electrically multiplexed by a aggregation function card 55. The optical signals from each multiplexed signal is then sent to the WDM module 96 where up to sixteen/thirty-two signals sent from up to sixteen/thirty-two aggregation function cards are optically multiplexed (WDM) and sent via the fiber optic line 28 to the central office 22. The fiber optic link 28 may include up to sixteen/thirty-two OC-48 or OC-192 links.

Table 1 below illustrates the type of services, format and possible capacity the network 20 may support for each residence. It should be understood that the list provided in Table 1 is exemplary. The services may vary in type and capability. In addition, future services not yet conceived may be used with the network 20, as indicated by the auxiliary service listing.

TABLE 1
Customer Services

| SERVICE | FORMAT | CAPACITY | |
|---|---|---|---|
| HDTV | MPEG-2 | 122 | Mbps |
| Movie on demand/DVD | MPEG-2 | 122 | Mbps |
| D1-Video cable/video | MPEG-2 | 122 | Mbps |
| conferencing | | | |
| LAN/HUB | Ethernet/TCP/IP | 10/100 | Mbps |
| Digital Telephony | VoIP | 2.28 | Mbps |
| Local/Long distance | | | |
| Auxiliary | Provisional | >122 | Mbps |

Table 2 below illustrates the simultaneous customer capabilities available utilizing OC-3 or OC-12 pipes. It should be understood that different types of fiber optic links may be utilized. This list is merely exemplary of a possible configuration of the network 20 and its customer capabilities.

TABLE 2
Simultaneous Customer Capabilities

| Customer | Video | | Internet | |
|---|---|---|---|---|
| Bandwidth | Channels | | bandwidth | Voice channels |
| OC-3 | 1 | channel | 10 Mbps | 10 channels |
| 155 Mbps | 122 | Mbps | | DS-0 |
| OC-12 | 4 | channels | 10/100 Mbps | 10 channels |
| 622 Mbps | 4 × 122 | Mbps | | DS-0 |

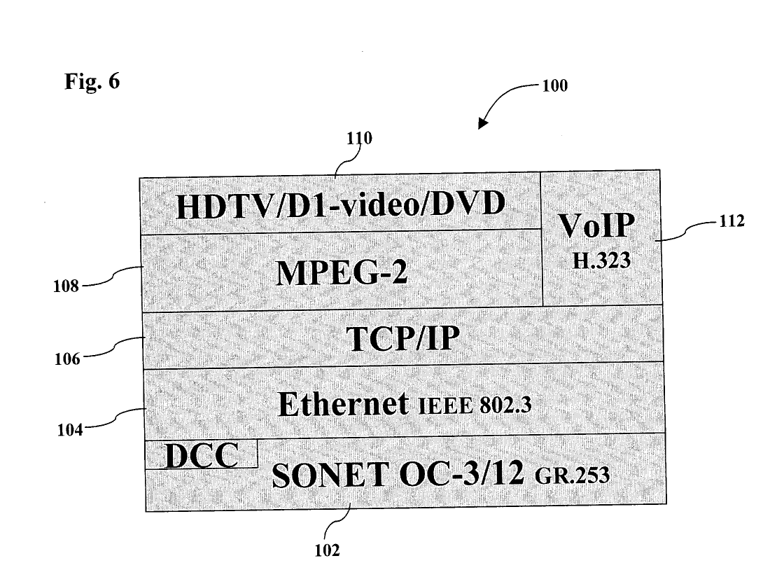

FIG. 6 is a block diagram of an exemplary protocol stack 100 for use in providing multiple services to a residence through the network 20. The protocol stack may include a SONET OC-3/12 layer 102. Preferably, the stack utilizes the OC-3/12 digital communication channel (DCC). The next layer is the Ethernet layer 104. The stack also includes the IP/TCP layer 106, the MPEG-2 layer 108, the HDTV/D1-video/DVD layer 110, and the VoIP layer 112. Also, although the protocols illustrated are preferred, any protocol may be utilized to provide efficient utilization of the bandwidth for multiple simultaneous services to the customer. Additionally, the protocol stack may accommodate additional new services as they are introduced to the customer.

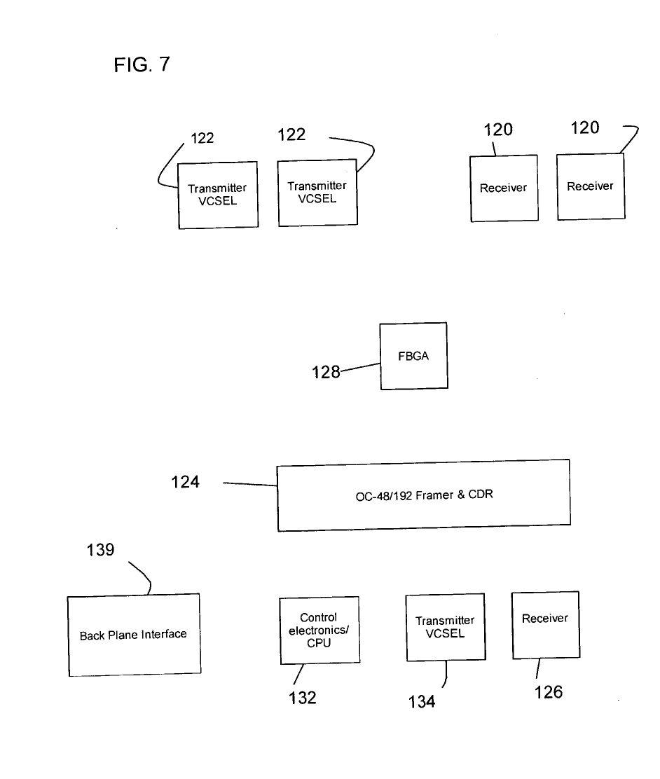

FIG. 7 is a high level diagram of the components of the curbside hub 26 of the network 20 in the preferred embodiment of the present invention. In the preferred embodiment of the present invention, for each residence, a dedicated receiver 120 and transmitter 122 may be utilized. The receiver and transmitter may be combined into one integrated transceiver. The transmitter and receivers may be Vertical Cavity Surface Emitting Semiconductor Lasers (VCSELs). Each VCSEL is used for one customer residence. The signals transmitted from the residence are sent to the receiver 120 and multiplexed at the curbside hub. The receiver signals are then sent to a framer and Clock and Date Recovery Unit (CDR) 124 for transmission via a OC-48/192 fiber optic link 28 to the central office 22. The framer 124 sends the packets of data to a receiver 126 for transmission to a Field Programmable Gate Array (FPGA) 128. The FPGA 128 provides control functions for the framer 124. A back plane interface 139 for servicing of the curbside hub by a technician or to interface with the CPU. The interface may be a serial or parallel interface. The curbside hub may also include a control electronics/power converter 132. In addition, the control electronics/power converter preferably includes a CPU for controlling power supply, electronics, synchronization and service interface. For transmission of data, the transmitter 122 provides data to the framer 124, which sends the signal to a transmitter 134 and the FPGA. The transmitter 134 may also be VCSELs. The curbside hub allows transmission of data between the residence and the central office, thus providing bidirectional transfer of information.

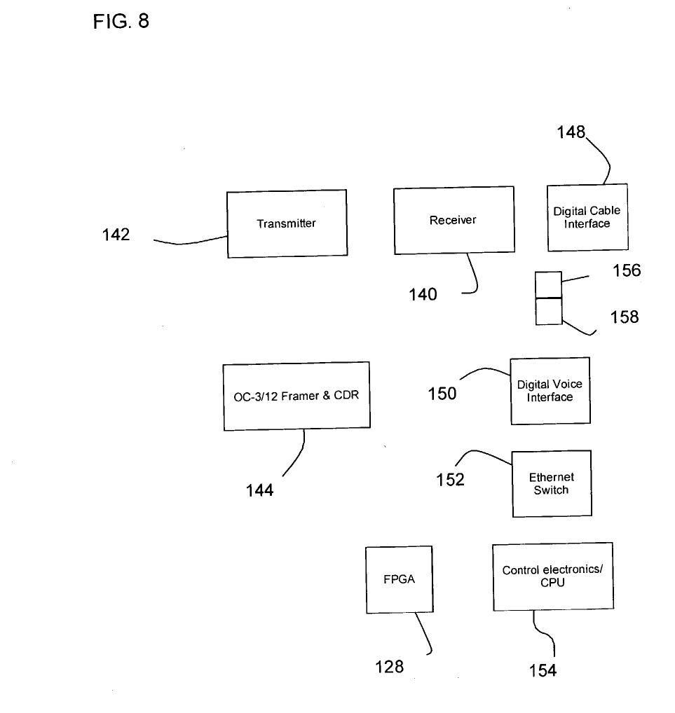

FIG. 8 is a high level diagram of the components of the home-side interface unit 44 of the network 20 in the preferred embodiment of the present invention. The home-side interface unit may include a single receiver 140 and a transmitter 142 (preferably utilizing VCSEL). The receiver and transmitter may be integrated into one transceiver. In addition, the home-side interface unit may include an OC-3 or OC-12 framer and CDR 144 and a FPGA 128. Additionally, the home-side interface unit may include a cable interface 148, a voice interface 150, an Ethernet switch 152 and a control electronics/CPU 154. The status of the home-side interface unit may be indicated by several LEDs 156 and 158 to indicate normal and abnormal conditions (e.g., green indicating normal operations while red indicates a malfunction in the unit).

The home-side interface unit 44 is preferably located within or in the general vicinity of the residence. The home-side interface unit provides the interface for the receipt and transmission of multiple services. The receiver 140 and transmitter 142 provide SONET frames to and from the framer 144.

With reference to FIGS. 1-8, the operation of the network 20 will now be explained. The curbside hub 26 provides multiple services to several residences (e.g., 24 and 30). The curbside hub allows bidirectional transfer of information from both the residences and the central office 22. The curbside hub is preferably located within the vicinity of the residences it services. The curbside hub may service several homes. When receiving service signals from the central office, the fiber optic link 28 is used. Preferably, an OC-48 or OC-192 fiber optic link is used, although any fiber optic link may be used in the network 20. The signals, preferably in an IP over SONET frame format, are received and separated into separate channels by the demultiplexer 136 within the curbside hub. The demultiplexed signal is then sent, via the fiber optic link 40 (through a OC-3 or OC-12 pipe), to the appropriate home-side interface unit 44 determined by the curbside hub. The home-side interface unit receives the signals sent via the link 40 and routes the signals to the appropriate service interface (e.g., telephone service, video on demand, high speed Internet access, etc.).

The user at the residence 24 may send signals via the link 40 through the home-side interface unit 44 to the curbside hub 26. The curbside hub receives each signal associated with a residence. Each aggregation function card may receive up to sixteen separate service signals. The signals are aggregated through electric multiplexing (i.e., TDM) by the framer 124. If more than one aggregation function card is being utilized by the curbside hub, the aggregation function card sends the signals to the WDM module 94. The WDM module receives signals from several aggregation function cards and optically multiplexes the signals (i.e., WDM) which is appropriately transmitted over one or more links 28 to the central office 22 (through an OC-48 or OC-192 fiber optic link).

The network 20 provides many advantages over existing systems. The present invention provides all-digital multiple services to a customer via a fiber optic link in a very cost-effective and resource efficient manner. The network may be used within standard IP or packet over SONET frames. Additionally, the network is scale-able and customizable for each customer.

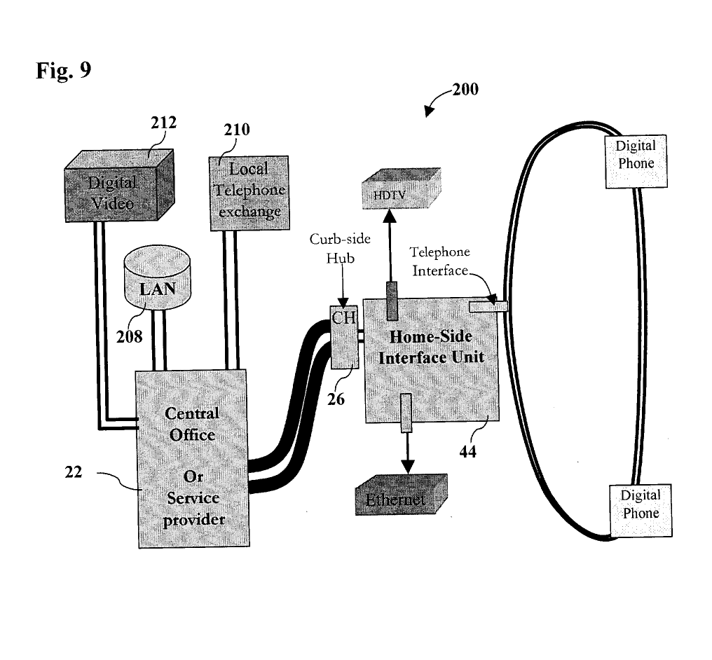

FIG. 9 is a simplified block diagram of the end to end network 200 illustrating a plurality of services available from the central office 22 in the preferred embodiment of the present invention. The network 200 includes a home side interface unit, the curbside hub 26, the central office 22. In addition, the central office provides a plurality of services from a Local Area Network (LAN) 208, a local telephone exchange 210, and a digital/video service provider 212.

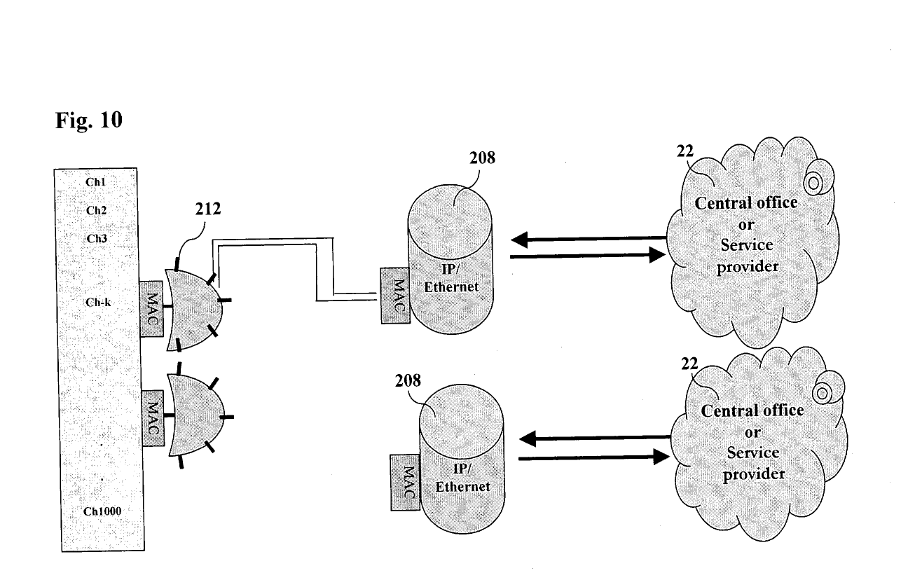

FIG. 10 is a simplified block diagram of the digital cable system architecture in a digital cable broadcast scheme 290 for the network 200 representing a bank of 1000 independent cable channels of FIG. 9. The central office 22 communicates with a plurality of IP/Ethernet components 212 and 208.

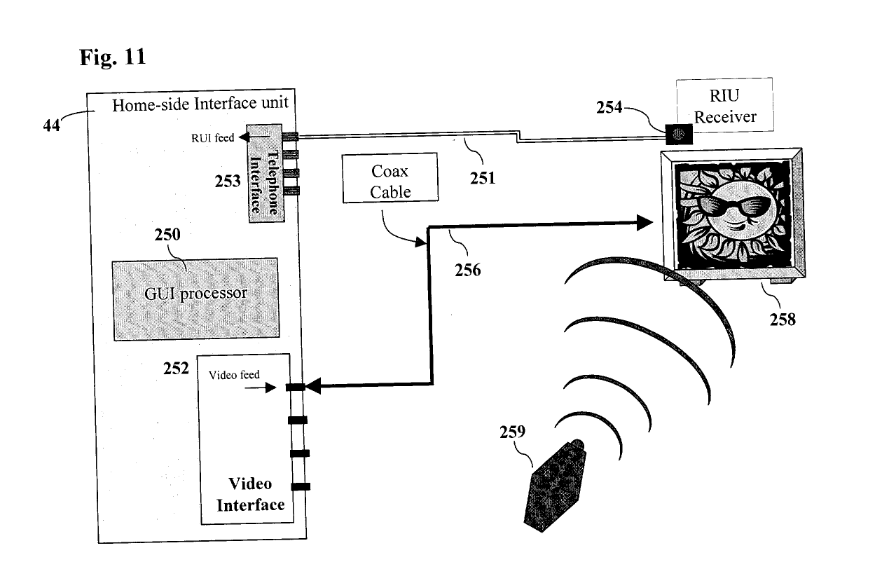

Referencing FIGS. 9 and 10, the homeside interface unit 44 generates a graphical user interface (GUI) and transmits it over a coax cable to a television (shown in FIG. 11). A user may scroll down the GUI and select a desired channel. The homeside interface unit associates the channel with a unique Media Access Control (MAC) address and generates an IP/Ethernet packet with source and designation MAC/IP addresses. Next, the subscriber card sends a control signal over the DCC relating any end-to-end service request and payload distribution. The curbside hub 26 includes an aggregation function card 55 (shown in FIG. 4). The aggregation function card 55 aggregates all subscriber signals and may map the subscriber DCC signal to a hub DCC signal or terminate for processing.

All the aggregated hub signals are optically multiplexed and sent to the central office 22. The central office may be a service provider. The central office optically demultiplexes the signals. Each signal is passed through a digital cross connect or router (routing the voice, LAN and video signals to the appropriate destinations). The video signal request is sent to the destination Ethernet address, replying with a reversed designation/source address signal to the subscriber during this continued “hand shaking.” This Ethernet MAC address connects with “N” MAC address. Each MAC address is associated with a channel. The processed DCC signal determines authorization of this channel. When authorized, the requested MAC-to-MAC addressed connections are made and the “hand shaking” is completed.

FIG. 11 is a simplified block diagram of a Remote User Interface (RUI) type-1 system architecture within the residence 24. The RUI type-1 architecture may utilize a standard infrared remote control. The homeside interface unit 44 may include a GUI processor 250 and a video interface 252. The homeside interface unit provides video signals via a coax cable 256 for transmission of video signals to a televison 258. A remote control unit 259 may be used to interface with the television 258. The remote control unit may communicate with the RUI receiver via a wireless link, such as an infrared signal. The RUI receiver communicates with the homeside interface unit via the twisted pair link 251 to the telephone interface 253.

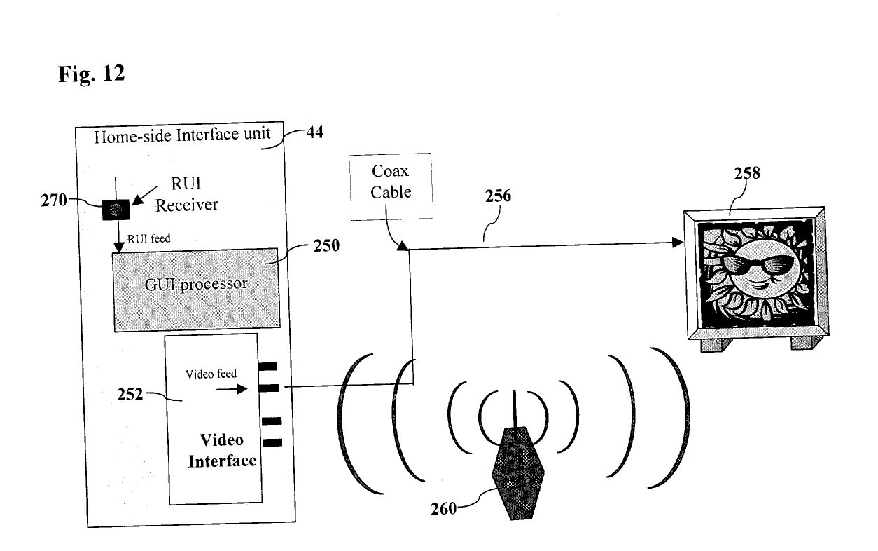

FIG. 12 is a simplified block diagram of a RUI type-2 system architecture within the residence 24. The RUI type-2 system utilizes an RF remote control 260. The homeside interface unit 44 may optionally incorporate a RUI RF receiver 270. The remote control 260 unit may communicate via a wireless link.

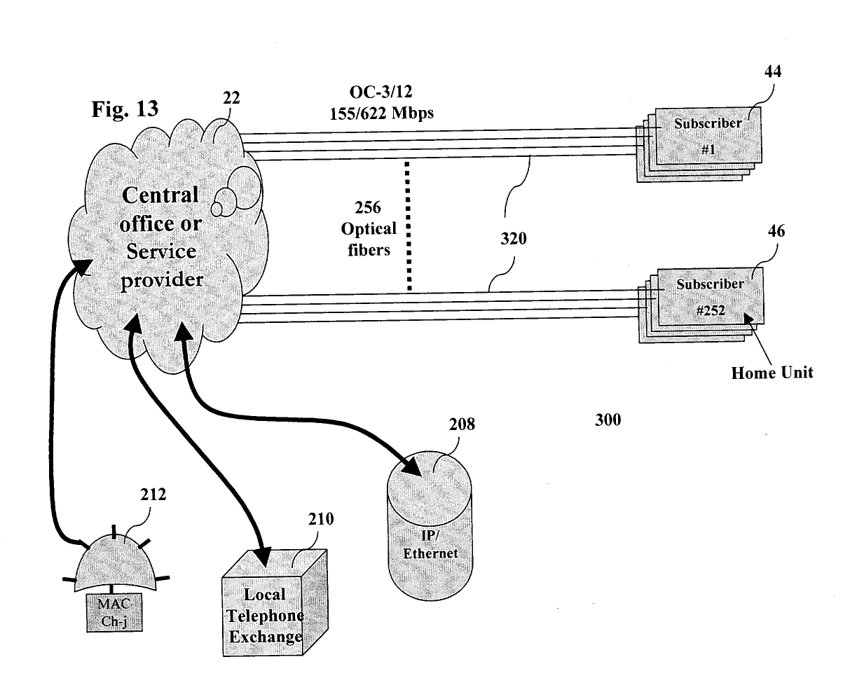

FIG. 13 is a simplified block diagram of a network 300 in a first alternate embodiment of the present invention. The network 300 includes a central office 22 providing services obtained form a local telephone exchange 304, a LAN 306, and a channel “j” broadcast 308. The central office provides a OC-12 or other type of fiber optics links 320 directly to each subscriber 310.

The network 300 may include video MPEG-2 services having encoded signals transmitted at 122 Mbps, and 10 DS-0's. Additionally, a LAN TCP/IP may be connected at a rate of 100 Mbps. The video multi-cast supports a plurality of subscribers/channel/LAN.

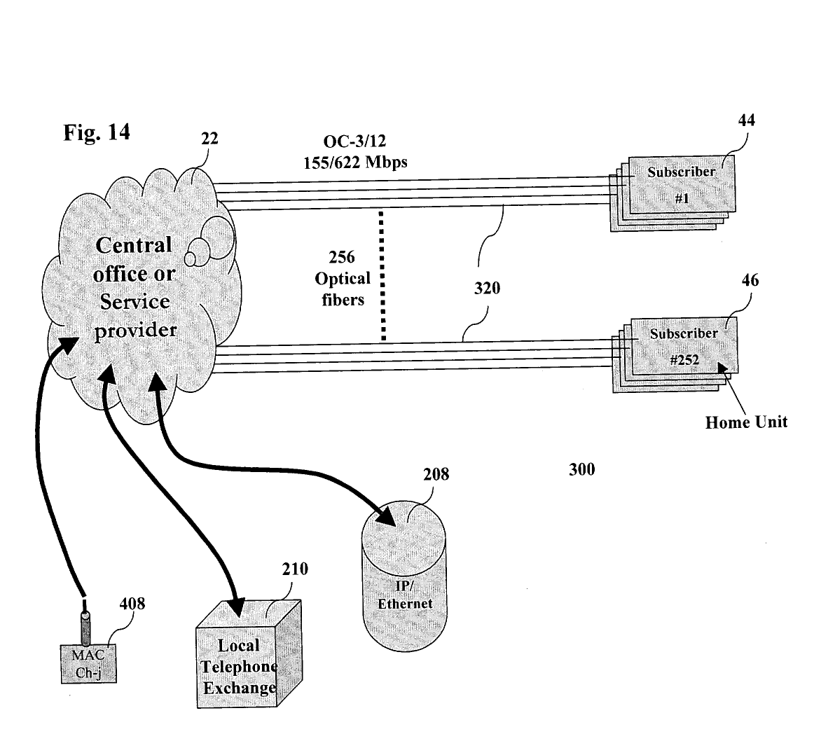

FIG. 14 is a simplified block diagram of a network 400 in a second alternate embodiment of the present invention. The network 400 includes a central office 402 providing services obtained from a local telephone exchange 404, a LAN 406, and a single channel “j” user connection 408 having a MAC address broadcast. The central office provides a OC-12 or other type of fiber optics link 420 directly to each subscriber 410. The network 400 provides similar services as the network 300.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for providing multiple services to a destination on a fiber optic network, said system comprising:
a central office providing multiple services to a plurality of destinations, each destination having a home-side interface unit coupled to a plurality of service interface units providing services to an occupant of each destination; and
a curbside hub connected to the central office via a first fiber optic link, said curbside hub connected to each destination by a home-side fiber optic link;
whereby said curbside hub transfers signals to and from each destination.

2. The system for providing multiple services to a plurality of destinations of claim 1 wherein said curbside hub multiplexes signals received from the plurality of service interface units and transfers the multiplexed signals to the central office.

3. The system for providing multiple services to a plurality of destinations of claim 2 wherein said curbside hub wavelength division multiplexes the signals sent to said central office.

4. The system for providing multiple services to a plurality of destinations of claim 1 wherein said curbside hub demultiplexes signals received from the central office and transfers the demultiplexed signals to a destination designated by the central office.

5. The system for providing multiple services to a plurality of destinations of claim 4 wherein said curbside hub electrically multiplexes and demultiplexes the signals transferred between the curbside hub and the plurality of home-side interface units.

6. The system for providing multiple services to a plurality of destinations of claim 5 wherein said curbside hub includes an aggregation function card for multiplexing the signals received from each home-side interface unit.

7. The system for providing multiple services to a plurality of destinations of claim 1 wherein the signals are formatted as Synchronous Optical Network (SONET) frames.

8. The system for providing multiple services to a plurality of destinations of claim 1 wherein said curbside hub includes means for demultiplexing and means for multiplexing signals transferred between the plurality of home-side interface units and said central office.

9. The system for providing multiple services to a plurality of destinations of claim 8 wherein the means for multiplexing signals includes an aggregation card for multiplexing signals received from the plurality of home-side interface units.

10. The system for providing multiple services to a plurality of destinations of claim 9 wherein the aggregation card time division multiplexes signals received from the plurality of home-side interface units.

11. The system for providing multiple services to a plurality of destinations of claim 10 wherein the curbside hub includes a plurality of aggregation cards, said cards sending signals to a wavelength division multiplexer for optically multiplexing signals received from the aggregation cards and transferring the signals to said central office.

12. The system for providing multiple services to a plurality of destinations of claim 1 wherein the services provided to a destination are multiplexed in a format allowing the simultaneous transmission of services over the home-side fiber optic link.

13. The system for providing multiple services to a plurality of destinations of claim 1 wherein the first fiber optic link is an OC-48 fiber optic link.

14. The system for providing multiple services to a plurality of destinations of claim 1 wherein the first fiber optic link is an OC-192 fiber optic link.

15. The system for providing multiple services to a plurality of destinations of claim 1 wherein the home-side fiber optic link is an OC-3 fiber optic link.

16. The system for providing multiple services to a plurality of destinations of claim 1 wherein the home-side fiber optic link is an OC-12 fiber optic link.

17. The system for providing multiple services to a plurality of destinations of claim 1 wherein the multiple services are provided simultaneously to the destination by overlaying each service on a SONET frame transmitted to and from each home-side interface unit.

18. The system for providing multiple services to a plurality of destinations of claim 17 wherein one of the services includes access to the Internet.

19. The system for providing multiple services to a plurality of destinations of claim 17 wherein one of the services is digital cable television.

20. The system for providing multiple services to a plurality of destinations of claim 17 wherein one of the services is digital video on demand.

21. The system for providing multiple services to a plurality of destinations of claim 17 wherein one of the services is an auxiliary digital/analog service operating with a baud rate over 122 Mbps.

22. The system for providing multiple services to a plurality of destinations of claim 17 wherein one of the services is a digital telephone service.

23. A system for providing multiple services to a destination via a fiber optic link, said system comprising:
a central office providing multiple services to a plurality of destinations, each destination having a home-side interface unit coupled to a plurality of service interface units providing services to an occupant of each destination; and
a curbside hub connected to the central office via a first fiber optic link, said curbside hub connected to each destinations by a home-side fiber optic link;
said curbside hub demultiplexing signals received from the central office via the first fiber optic link and wavelength division multiplexing signals being sent to said central office via the first fiber optic link;
said curbside hub time division multiplexing signals received from each home-side interface sending signals to said curbside hub via the home-side fiber optic link;
whereby said signals provide services via the first fiber optic link and each home-side fiber optic link to each destination.

24. The system for providing multiple services to a plurality of destinations of claim 23 wherein said curbside hub includes a plurality of aggregation cards, each aggregation card multiplexing and demultiplexing signals transferred between said curbside hub and a select number of destinations.

25. The system for providing multiple services to a plurality of destinations of claim 24 wherein signals received by each aggregation card are transferred to a wavelength division multiplex module, said wavelength division multiplex module optically multiplexing the signals and transferring the signals to the central office via the first fiber optic link.

26. A system for providing multiple services to a destination via a fiber optic link, said system comprising:
a central office providing multiple services to a plurality of destinations, each destination having a home-side interface unit coupled to a plurality of service interface units providing services to an occupant of each destination; and
a curbside hub connected to the central office via a first fiber optic link, said curbside hub connected to each destinations by a home-side fiber optic link;
said curbside hub having means for optically multiplexing and demultiplexing signals transferred between said curbside hub and said central office;
said curbside hub having means for electrically multiplexing and demultiplexing signals transferred between said curbside hub and each home-side interface unit.

27. The system for providing multiple services to a plurality of destinations of claim 28 further comprising means for providing multiple services via a signaling protocol overlaying each service on a frame transmitted via the first fiber optic link and the home-side fiber optic link.

28. A method of providing multiple simultaneous services to a plurality of destinations via a fiber optic network, said method comprising the steps of:
providing services via a first fiber optic link from a central office to a curbside hub, said curbside hub connected to a plurality of home-interface units by a plurality of home-side fiber optic links, each home-side unit located at a destination;
demultiplexing signals associated with the services by the curbside hub;
determining a destination for each demultiplexed signal; and
directing each determined, demultiplexed signal to a destination via one of the home-side fiber optic links, said directed signal providing at least one service to the destination.

29. The method of providing multiple simultaneous services to a plurality of destinations of claim 28 further comprises the steps of:
electrically multiplexing signals sent from each destination by the curbside hub; and
transferring the multiplexed signals to the central office.
